(19) United States
(12) Patent Application Publication
(10) Pub. No.: US 2013/0343161 A1
(43) Pub. Date: Dec. 26, 2013

(54) APPARATUS AND METHOD FOR TRANSMITTING ACOUSTIC SIGNAL USING HUMAN BODY

(71) Applicant: Electronics & Telecommunications Research Institute, Daejeon (KR)

(72) Inventors: Tae Wook KANG, Daejeon (KR); Jung Hwan Hwang, Daejeon (KR); Sung Eun Kim, Daejeon (KR); Sung Weon Kang, Daejeon (KR); Sung Won Sohn, Daejeon (KR)

(73) Assignee: Electronics & Telecommunications Research Institute, Daejeon (KR)

(21) Appl. No.: 13/904,287

(22) Filed: May 29, 2013

(30) Foreign Application Priority Data
Jun. 25, 2012 (KR) 10-2012-0067783

(51) Int. Cl. G10K 11/02; G10K 11/24

(52) U.S. Cl. CPC G10K 11/02; G10K 11/24
USPC 367/117

(57) ABSTRACT

An apparatus and method for transmitting an acoustic signal using a human body are disclosed. The acoustic signal transmitting apparatus includes: a pre-processor configured to perform processing for compensating for transfer distortion of an acoustic signal; a controller configured to control beamforming of the acoustic signal whose transfer distortion has been compensated for; and a plurality of acoustic devices configured to transfer the acoustic signal to a human body which the plurality of acoustic devices have contacted, through beamforming according to a control of the controller. Accordingly, it is possible to to transmit acoustic signals using a human body as a medium with minimum signal loss and distortion.

### CLAIM FOR PRIORITY

This application claims priority to Korean Patent Application No. 10-2012-0067783 filed on Jun. 25, 2012 in the Korean Intellectual Property Office (KIPO), the entire contents of which are hereby incorporated by reference.

### BACKGROUND

1. Technical Field

Example embodiments of the present invention relate in general to an acoustic signal transmission method, more specifically, to an apparatus and method for transmitting an acoustic signal using a human body as a communication channel.

2. Related Art

A general process of transferring acoustic signals includes: at an acoustic signal transmitting apparatus, outputting an acoustic signal in an audio frequency band (for example, a frequency band lower than 20 kHz); and at an acoustic signal receiving apparatus, such as an earphone, a headset, etc., receiving the acoustic signal through a cable and converting the acoustic signal to a signal in the audio frequency band. However, since the acoustic signal receiving apparatus is located close to a user's ears, the user is likely to suffer from noise, and also there is inconvenience in using the acoustic signal receiving apparatus since it receives acoustic signals through a cable.

Lately, in order to overcome the problem of the conventional acoustic signal transferring process as described above, a method of using a human body as a communication channel has been proposed.

Technology of transmitting acoustic signals using a human body is to transmit acoustic signals through a human body, instead of a cable for transmission of acoustic signals, and reconstruct the acoustic signals without using a separate receiver.

However, if acoustic signals enter perpendicular to a human body when an acoustic signal transmitting apparatus transmits the acoustic signals through the human body, a part of the acoustic signals is coupled in a horizontal direction when transmitted along the human body, resulting in coupling loss.

Also, when the acoustic signals are transferred to the human body, signal distortion occurs due to the transfer properties of the human body and acoustic devices contacting the human body.

### SUMMARY

Accordingly, example embodiments of the present invention are provided to substantially obviate one or more problems due to limitations and disadvantages of the related art.

An example embodiment of the present invention provides an apparatus of transmitting an acoustic signal using a human body, capable of minimizing signal loss and distortion when an acoustic signal is transmitted using a human body as a medium.

Another example embodiment of the present invention also provides a method of transmitting an acoustic signal using a human body, capable of minimizing signal loss and distortion.

In an example embodiment, an acoustic signal transmitting apparatus includes: a pre-processor configured to perform processing for compensating for transfer distortion of an acoustic signal; a controller configured to control beamforming of the acoustic signal whose transfer distortion has been compensated for; and a plurality of acoustic devices configured to transfer the acoustic signal to a human body which the plurality of acoustic devices have contacted, through beamforming according to a control of the controller.

The pre-processor may perform processing for compensating for at least one of frequency distortion of the acoustic devices and transfer frequency distortion of the human body.

The controller may select at least one acoustic device that is to be used for beamforming among the plurality of acoustic devices, and control the phase of an acoustic signal that is transferred through the selected at least one acoustic device to thereby perform beamforming.

The plurality of acoustic devices may be immersion acoustic devices or made of a material having acoustic impedance that matches acoustic impedance of the human body. Also, the plurality of acoustic devices may have a linear arrangement structure in which the centers of the acoustic devices are aligned along a straight line or a planar arrangement structure in which the centers of the acoustic devices are positioned in a circle or rectangle region.

The acoustic signal transmitting apparatus may further include a signal amplifier configured to amplify the acoustic signal provided from the pre-processor such that the acoustic signal drives the plurality of acoustic devices. Also, the acoustic signal transmitting apparatus may further include a contact sensor configured to sense whether the plurality of acoustic devices have contacted the human body.

In another example embodiment, an acoustic signal transmitting apparatus includes: a pre-processor configured to perform processing for compensating for transfer distortion of an acoustic signal and to control beamforming of the acoustic signal; and a plurality of acoustic devices configured to transfer the acoustic signal whose transfer distortion has been compensated for to a human body which the plurality of acoustic devices have contacted, through beamforming.

The pre-processor may perform processing for compensating for at least one of frequency distortion of the acoustic devices and transfer frequency distortion of the human body.

The pre-processor may control beamforming by controlling the phase of an acoustic signal that is transferred through the plurality of acoustic devices.

In still another example embodiment, an acoustic signal transmitting method in which an acoustic signal transmitting apparatus transmits an acoustic signal using a human body includes: performing pre-processing for compensating for transfer distortion of an acoustic signal; controlling beamforming of the acoustic signal whose transfer distortion has been compensated for; and transferring the acoustic signal to the human body through the beamforming.

The acoustic signal transmitting method may further include, after performing the pre-processing for compensating for the transfer distortion of the acoustic signal, amplifying the acoustic signal subjected to the pre-processing.

The performing of the pre-processing for compensating for the transfer distortion of the acoustic signal may include performing processing for compensating for at least one of frequency distortion of an acoustic device which is used to transfer the acoustic signal, and transfer frequency distortion of the human body

The controlling of the beamforming of the acoustic signal whose transfer distortion has been compensated for may include controlling the phase of the acoustic signal whose transfer distortion has been compensated for.

Therefore, according to the apparatus and method for transmitting acoustic signals using a human body, as described above, acoustic signals may be transferred to the human body by compensating for the frequency characteristics of the acoustic signals in consideration of the frequency distortion characteristics of acoustic devices and transfer distortion characteristics of the human body, by amplifying the magnitudes of the acoustic signals to magnitudes for driving the acoustic devices, and then by performing beamforming such that the acoustic signals are incident to the human body in a direction diagonal to the human body, instead of a direction perpendicular to the human body.

Accordingly, it is possible to transfer acoustic signals using the human body without having to utilize a separate receiver for receiving acoustic signals, resulting in improvement of use convenience.

Also, by configuring the acoustic devices with immersion acoustic devices or with a matching material having impedance similar to that of the human body in order to transfer acoustic signals only through the human body, unnecessary noise that may be generated in the vicinity of a user which the acoustic devices have contacted may be prevented.

In addition, by performing beamforming on acoustic signals that are transferred through the plurality of acoustic devices such that the acoustic signals are incident in a direction diagonal to the human body, signal loss may be minimized, and by compensating for frequency distortion of the acoustic devices and transfer distortion of the human body, the quality of acoustic signals that are transferred through the human body may be improved.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view for explaining a method of transmitting an acoustic signal using a human body, according to an embodiment of the present invention;

FIG. 2 is a block diagram showing the configuration of an acoustic signal transmitting apparatus according to an embodiment of the present invention;

FIG. 3 is a conceptual view for explaining a signal processing function of a pre-processor shown in FIG. 2 in detail;

FIG. 4 is a table showing acoustic impedances for individual mediums for explaining a material for an acoustic device shown in FIG. 2;

FIG. 5 is a conceptual view for explaining the operation principle of a contact sensor shown in FIG. 2; and

FIG. 6 is a flowchart showing a method of transmitting an acoustic signal using a human body, according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention; however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

In the following description, a term “acoustic signal” means a signal including an audio frequency band.

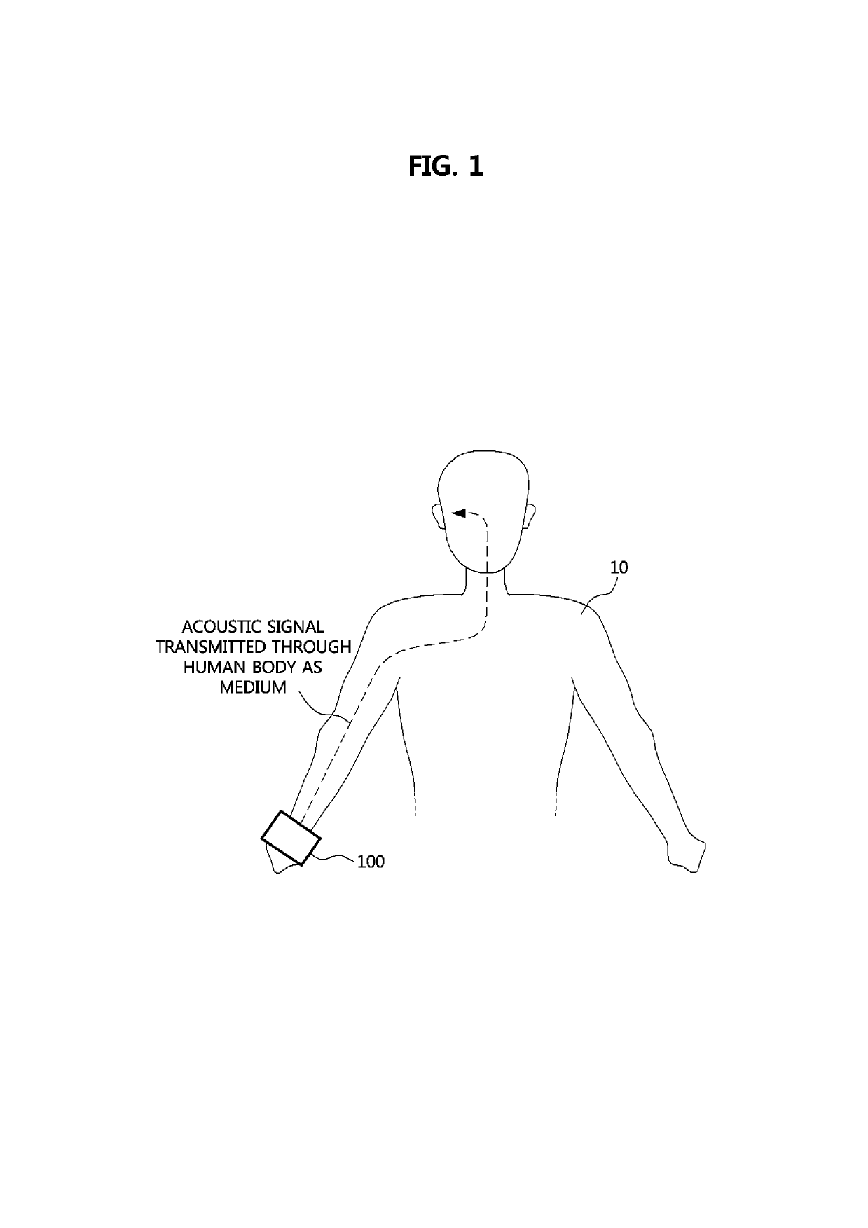

FIG. 1 is a conceptual view for explaining a method of transmitting an acoustic signal using a human body, according to an embodiment of the present invention.

Referring to FIG. 1, an acoustic signal transmitting apparatus 100 according to an embodiment of the present invention contacts a human body 10 to transmit an acoustic signal to a user's ears using the human body 10 as a medium.

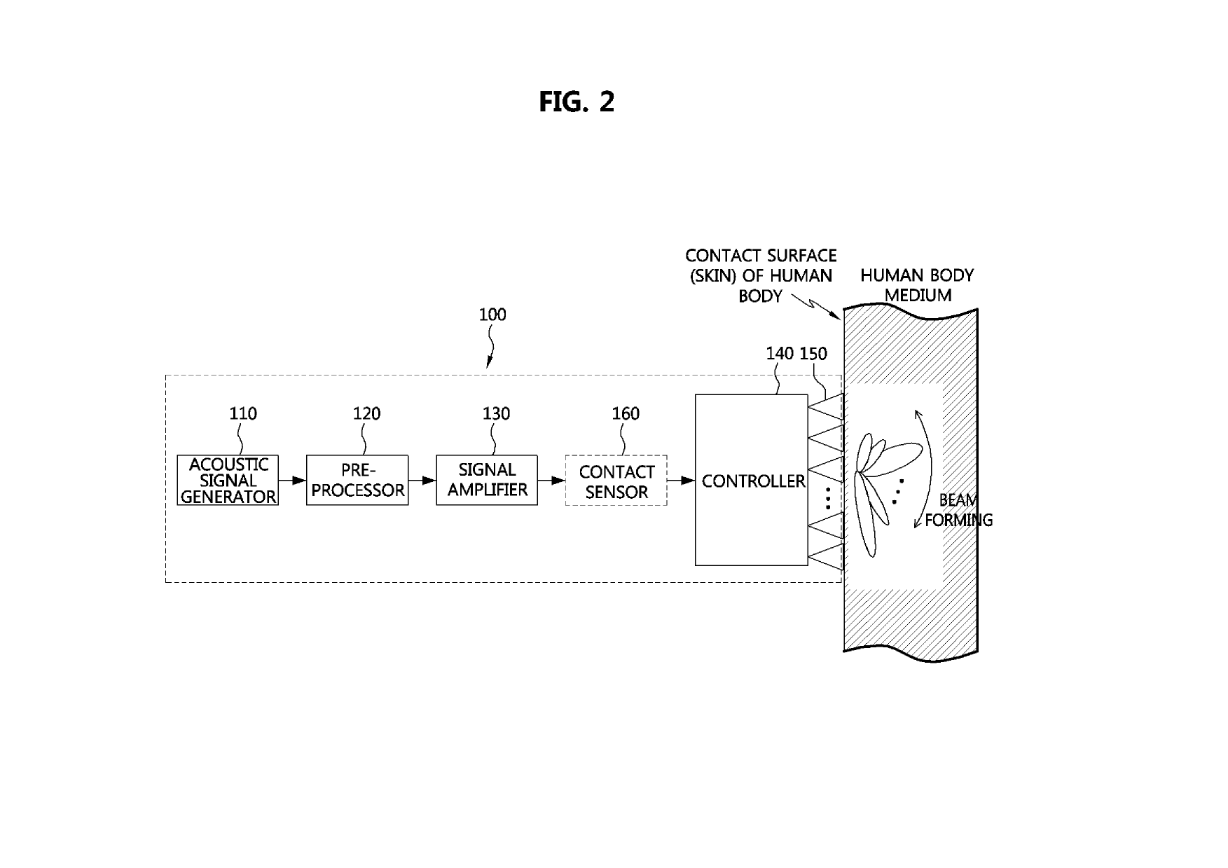

At this time, an acoustic device 150 (see FIG. 2) of components of the acoustic signal transmitting apparatus 100 contacts the human body 10 directly, and the acoustic device 150 is configured to match acoustic impedance of the human body 10. Accordingly, the acoustic signal is transmitted only through the human body 10 so that no noise is generated in the vicinity of the user which the acoustic device 150 has contacted.

Also, the user whose body part has contacted the acoustic signal transmitting apparatus 100 may hear sound of the acoustic signal through his/her ears without having to utilize a separate receiver.

FIG. 1 shows an example in which the acoustic signal transmitting apparatus 100 has contact a user's wrist to transmit an acoustic signal; however, the acoustic signal transmitting apparatus 100 may transmit acoustic signals regardless of which body part it has contacted.

FIG. 2 is a block diagram showing the configuration of the acoustic signal transmitting apparatus 100 according to an embodiment of the present invention.

Referring to FIG. 2, the acoustic signal transmitting apparatus 100 includes an acoustic signal generator 110, a pre-processor 120, a signal amplifier 130, a controller 140, and a plurality of acoustic devices 150. Also, the acoustic signal transmitting apparatus 100 may further include a contact sensor 160.

The acoustic signal generator 110 may transfer signals received from various acoustic sources directly to the pre-processor 120, or may convert the received signals into a format suitable for processing by the pre-processor 120 and then transfer the converted signals to the pre-processor 120. For example, the acoustic signal generator 110 may transfer sound sources with various formats (for example, MP3, WAV, AIFF, FLAC, APE, M4A, AAC, etc.) directly to the pre-processor 120, and may convert the sound sources into a specific format suitable for processing by the pre-processor 120 and then transfer the converted sound sources to the pre-processor 120.

The pre-processor 120 may compensate for signal distortion of the acoustic signals provided from the acoustic signal generator 110 in advance, wherein the signal distortion may be caused by the frequency characteristics of the acoustic devices 150 or when the acoustic signals are transferred through a human body.

The pre-processor 120 may perform signal processing, such as equalization and/or filtering, in order to compensate for the signal distortion.

The signal amplifier 130 receives the resultant acoustic signals from the pre-processor 120 and amplifies the magnitudes of the received acoustic signals to magnitudes capable of driving the acoustic devices 150. That is, the signal amplifier 130 amplifies the magnitudes of the acoustic signals such that the acoustic signals can be transferred to the human body through the acoustic devices 150.

The controller 140 controls the phases of acoustic signals provided to the individual acoustic devices 150 aligned in an array form, and the number of the acoustic devices 150 for transmission of acoustic signals, thereby performing beamforming on the acoustic signals that are to be output through the acoustic devices 150.

Since the controller 140 controls beamforming of acoustic signals, the acoustic signals are incident to the human body in a direction diagonal to the contact surface (or the skin) of the human body, not in a direction perpendicular to the contact surface of the human body, and accordingly, coupling loss is prevented, resulting in minimum loss in acoustic signals that are transmitted through the human body. The controller 140 may control beamforming such that acoustic signals are incident to the human body in a diagonal direction toward the user's ears.

The plurality of acoustic devices 150 may be aligned in various forms. For example, the acoustic device 150 may be configured to have a linear arrangement structure in which the centers of the acoustic devices 150 are aligned along a straight line or a planar arrangement structure in which the centers of the acoustic devices 150 are positioned in a circle or rectangle region.

Also, the direction of beamforming and the number of ones to be used for beamforming among the acoustic devices 150 may vary according to a direction in which the acoustic signal transmitting apparatus 100 is attached on the human body and/or according to the human body's part on which the acoustic signal transmitting apparatus 100 is attached, or by the user's setting.

The contact sensor 160 may be optionally included in the acoustic signal transmitting apparatus 100. The contact sensor 160 senses whether the acoustic devices 150 contact the human body and outputs a signal corresponding to a sensed contact, to thereby enable other components of the acoustic signal transmitting apparatus 100 to perform, according to a signal provided from the contact sensor 160, processing for generating an acoustic signal only when the acoustic devices 150 contact the human body and not processing when the acoustic devices 150 contact no human body, which prevents unnecessary power consumption.

If no contact sensor 160 is included in the acoustic signal transmitting apparatus 100, a separate switch may be provided in the acoustic signal transmitting apparatus 100 so that a user manipulates the switch to selectively operate the acoustic signal transmitting apparatus 100.

FIG. 2 shows an example in which the controller 140 is provided as an independent component; however, the functions of the controller 140 may be performed by the pre-processor 120.

Also, the arrangement of the components included in the acoustic signal transmitting apparatus 100 as shown in FIG. 2 and the processing order according to the arrangement of the components may change for easy implementation.

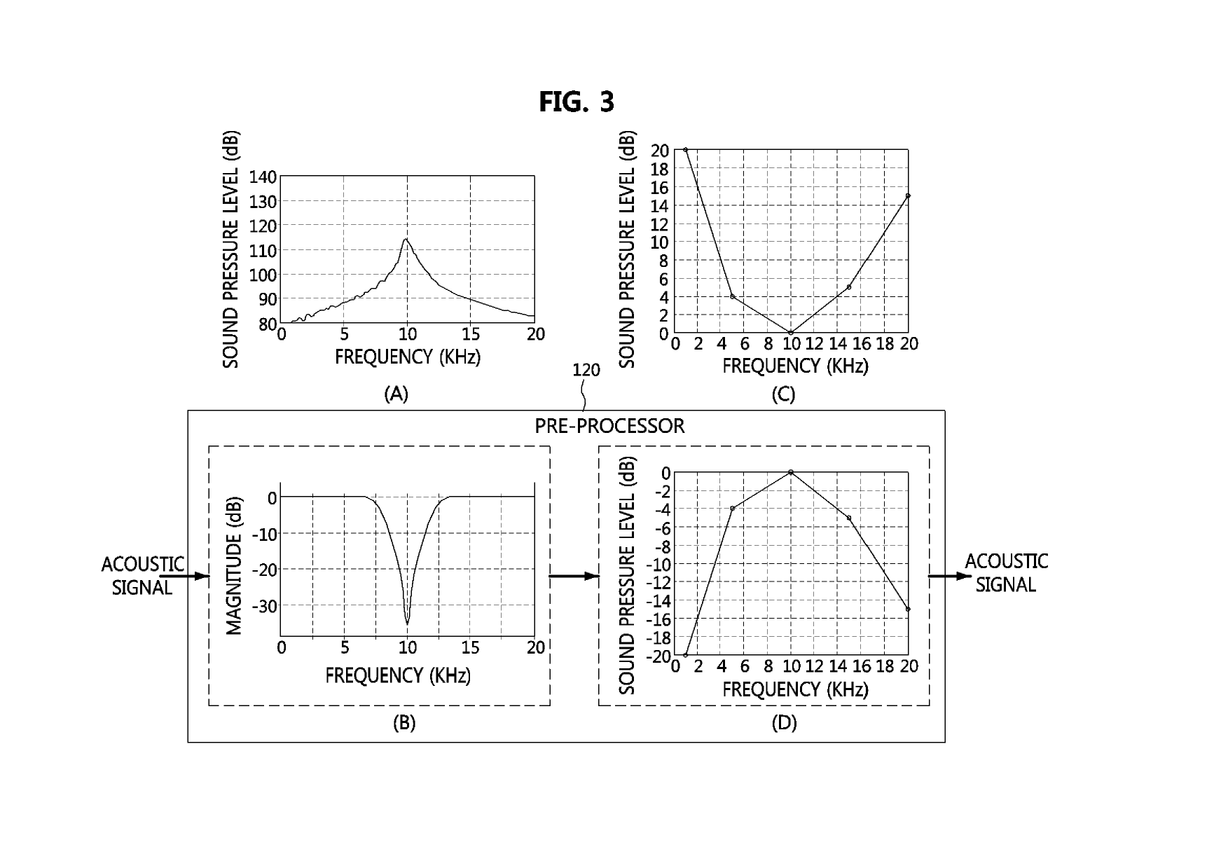

FIG. 3 is a conceptual view for explaining a signal processing function of the pre-processor 120 shown in FIG. 2 in detail.

Referring to FIG. 3, the pre-processor 120 may include an equalizer filter for compensation of acoustic device frequency distortion characteristics to compensate for frequency distortion characteristics of the acoustic devices 150, and an equalizer filter for compensation of human body transfer frequency distortion characteristics to compensate for frequency distortion characteristics by which acoustic signals are distorted according to a human body's transfer frequency distortion characteristics.

As shown in (a) of FIG. 3, if the acoustic devices 150 have frequency characteristics showing distortion at a specific frequency (for example, 10 kHz), the equalizer filter for compensation of acoustic device frequency distortion characteristics of the pre-processor 120 performs processing of compensating in advance for distortion at the specific frequency 10 kHz, as shown in (b) of FIG. 3, thereby minimizing distortion due to the frequency characteristics of the acoustic devices 150.

Also, if the frequency characteristics of a human body through which acoustic signals are transferred have characteristics as shown in (c) of FIG. 3, the equalizer filter for compensation of human body transfer frequency distortion characteristics of the pre-processor 120 performs equalization for compensating for frequency distortion characteristics, as shown in (d) of FIG. 3, thereby minimizing frequency distortion due to a human body's transfer characteristics.

FIG. 3 shows an example in which the pre-processor 120 first compensates for the frequency distortion of the acoustic devices 150 and then compensates for frequency distortion due to a human body's transfer characteristics; however, according to another embodiment, it is also possible that the pre-processor 120 first compensates for frequency distortion due to a human body's transfer characteristics and then compensates for the frequency distortion of the acoustic devices 150. Also, according to another embodiment, the equalizer filter for compensation of acoustic device frequency characteristics may be combined with the equalizer filter for compensation of human body transfer characteristics to configure a single equalizer filter for performing the functions of the two equalizer filters.

Each filter shown in FIG. 3 may be implemented as a digital signal processor (DSP), a finite impulse response (FIR) filter using a field programmable gate array (FPGA), or an analog filter using an analog device.

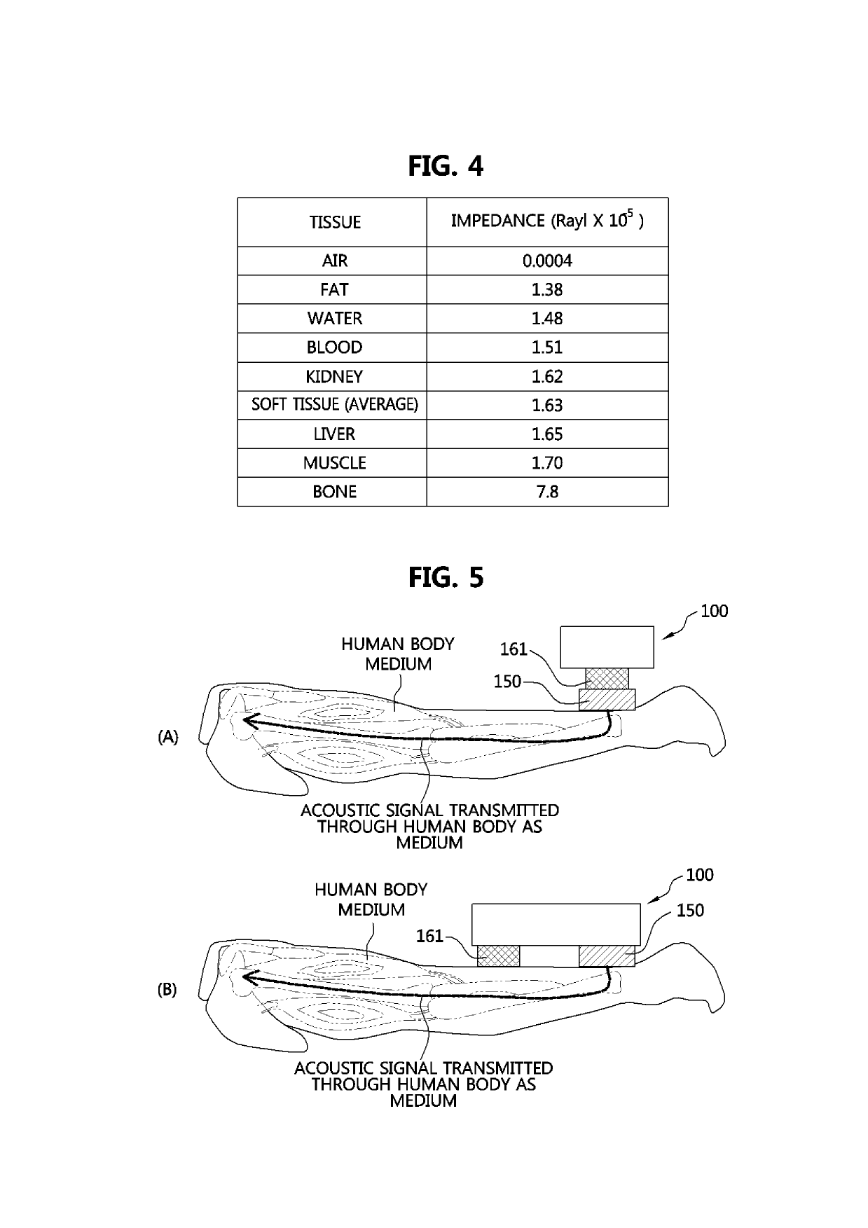

FIG. 4 is a table showing acoustic impedances for individual mediums for explaining a material for the acoustic devices 150 shown in FIG. 2.

Based on the acoustic impedances for individual mediums shown in FIG. 4, according to an embodiment of the present invention, an acrylic group, an urethane group, nitrile butadien rubber (NBR), ethylene prophlene diene monomer (EPDM), silicon, water-gel, and the like, which are polymer materials for general purpose, are used as a matching material for the contact surface between the acoustic devices 150 and the human body to have acoustic impedance similar to that of a human body's soft tissues, or immersion acoustic devices having the same acoustic impedance as water are used as the acoustic devices 150.

If a material having the same acoustic impedance as the human body's soft tissues or water is used to form the acoustic devices 150, the main part of a transmission signal cannot be transmitted in the air by reflectance as expressed as Equation (1) below.

X={(Z1−Z2)/(Z1+Z2)}² (1)

In Equation (1), X represents the strength-of-reflection coefficient, Z1 represents the acoustic impedance of a medium 1, and Z2 represents the acoustic impedance of a medium 2.

According to Equation 1, since the reflectance of the acoustic devices 150 with respect to air is 99% or more, a signal output from the acoustic devices 150 is little transmitted in the air.

Meanwhile, since the reflectance of the acoustic devices 150 approximates 0% when the acoustic devices 150 contact the human body's skin, the main part of a signal output from the acoustic devices 150 are transferred to the human body. Accordingly, acoustic signals are transferred only to a user which the acoustic devices 150 have contacted so that no undesired noise is generated in the vicinity of the user.

Also, since the human body functions as a waveguide for acoustic signals, acoustic signals may be transferred regardless of a location at which the acoustic devices 150 have contacted on the skin of a human body.

The acoustic devices 150 may be formed in various shapes, such as a ring, glasses, a bracelet, earrings, a watch, etc., capable of contacting the skin.

FIG. 5 is a conceptual view for explaining the operation principle of the contact sensor 160 shown in FIG. 2.

Referring to FIG. 5, the contact sensor 160 may be configured with a piezoelectric device 161 and may be connected to the back side of acoustic devices (150 of FIG. 2) to sense a contact of the acoustic devices 150 to the skin, as shown in (a) of FIG. 5.

Or, the piezoelectric device 161 may be, as shown in (b) of FIG. 5, connected to the acoustic signal transmitting apparatus 100, instead of being directly connected to the acoustic devices 150, to sense a contact of the acoustic devices 150 to the skin.

The contact sensor 160 may be configured with various devices other than the piezoelectric device 161. For example, the contact sensor 160 may be configured with an infrared device, or a device capable of sensing even small changes in current or voltages from the acoustic devices 150, etc.

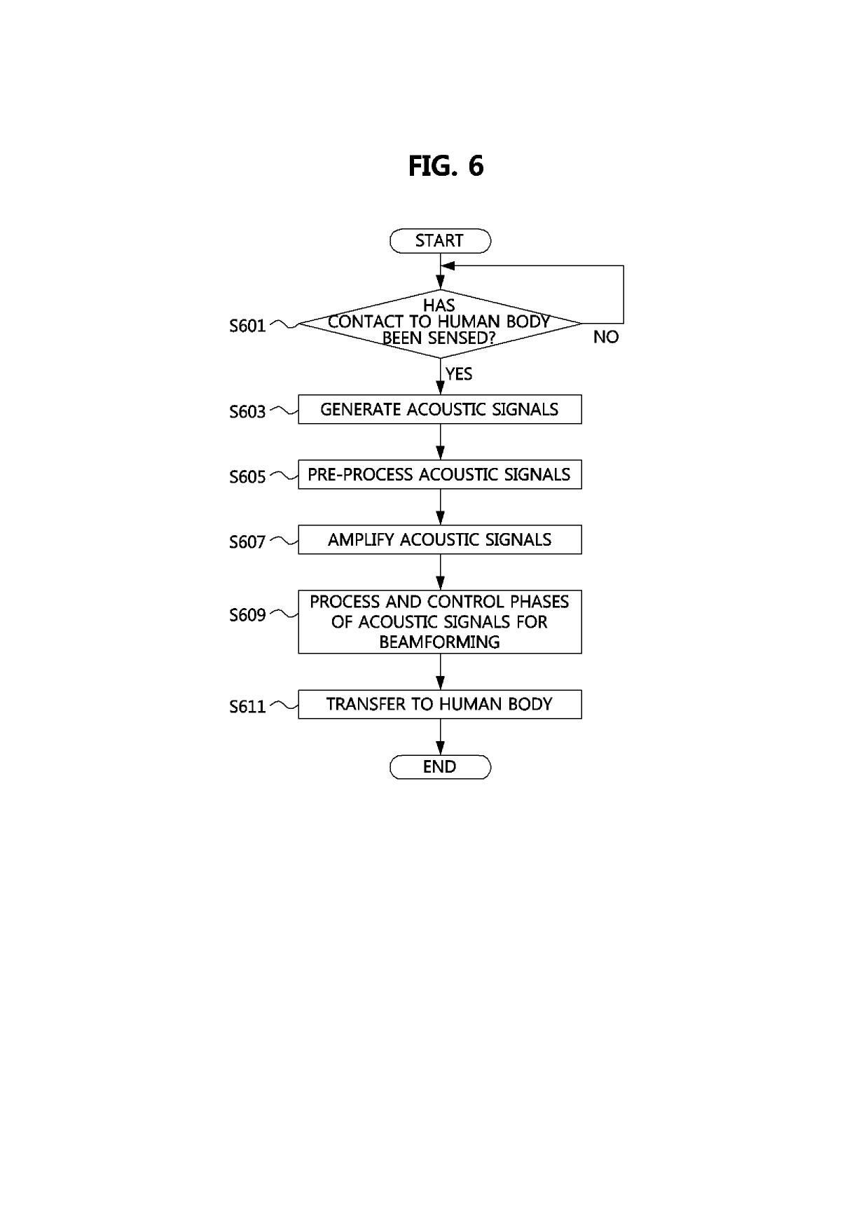

FIG. 6 is a flowchart showing a method of transmitting an acoustic signal using a human body, according to an embodiment of the present invention. FIG. 6 shows an example of an acoustic signal transmitting method which is performed by the acoustic signal transmitting apparatus 100.

Referring to FIGS. 2 and 6, the acoustic signal transmitting apparatus 100 determines whether a contact to a human body has been sensed (S601). The determination on whether a contact to a human body has been sensed may be performed by the contact sensor 160. However, if the acoustic signal transmitting apparatus 100 includes no contact sensor 160, a time at which a user has attached the acoustic signal transmitting apparatus 100 on his/her body may be determined as a time at which the acoustic devices 150 have contacted his/her body. Or, a separate interface for activating or deactivating the operation of the acoustic signal transmitting apparatus 100 may be provided in the acoustic signal transmitting apparatus 100 in order for a user to manipulate the interface and selectively operate the acoustic signal transmitting apparatus 100.

If it is determined that the acoustic devices 150 have contacted the human body, the acoustic signal transmitting apparatus 100 generates acoustic signals (S603). The acoustic signal transmitting apparatus 100 may use acoustic signals provided from an acoustic source as they are, or may convert the acoustic signals into a predetermined format for pre-processing.

Then, the acoustic signal transmitting apparatus 100 may perform pre-processing for compensating in advance for distortion of the acoustic signals (S605). At this time, the acoustic signal transmitting apparatus 100 may compensate in advance for signal distortion that is caused by the frequency characteristics of the acoustic devices 150 or when the acoustic signals are transferred through a human body, as shown in FIG. 3.

Also, the acoustic signal transmitting apparatus 100 may amplify the acoustic signals such that the acoustic signals can properly drive the acoustic device 150 (S607), select acoustic devices that are to be used for beamforming the acoustic signals, among the acoustic devices 150, control the phases of acoustic signals to be provided to the selected acoustic devices (S609), and then provide the acoustic signals whose phases have been controlled to the corresponding acoustic devices 150.

Next, the acoustic signal transmitting apparatus 100 transfers the acoustic signals, which have been amplified and whose phases have been controlled, to the human body through the acoustic devices 150 contacting the human body (S611). The acoustic signals are incident to the human body in a direction diagonal to the contact surface of the human body, through the beamforming, not in a direction perpendicular to the contact surface of the human body.

However, the order in which the operations S603 through S609 are executed, as shown in FIG. 6, is only exemplary, and the execution order may change according to implementation of the acoustic signal transmitting apparatus 100. For example, operation S609 of controlling acoustic signals for beamforming may be performed in operation S605 of pre-processing or before operation S607 of amplifying acoustic signals.

While the example embodiments of the present invention and their advantages have been described in detail, it should be understood that various changes, substitutions and alterations may be made herein without departing from the scope of the invention.

What is claimed is:

1. An acoustic signal transmitting apparatus comprising:
a pre-processor configured to perform processing for compensating for transfer distortion of an acoustic signal;
a controller configured to control beamforming of the acoustic signal whose transfer distortion has been compensated for; and
a plurality of acoustic devices configured to transfer the acoustic signal to a human body which the plurality of acoustic devices have contacted, through beamforming according to a control of the controller.

2. The acoustic signal transmitting apparatus of claim 1, wherein the pre-processor performs processing for compensating for at least one of frequency distortion of the acoustic devices and transfer frequency distortion of the human body.

3. The acoustic signal transmitting apparatus of claim 1, wherein the controller selects at least one acoustic device that is to be used for beamforming among the plurality of acoustic devices, and controls the phase of an acoustic signal that is transferred through the selected at least one acoustic device to thereby perform beamforming.

4. The acoustic signal transmitting apparatus of claim 1, wherein the plurality of acoustic devices are immersion acoustic devices or made of a material having acoustic impedance that matches acoustic impedance of the human body.

5. The acoustic signal transmitting apparatus of claim 1, wherein the plurality of acoustic devices have a linear arrangement structure in which the centers of the acoustic devices are aligned along a straight line or a planar arrangement structure in which the centers of the acoustic devices are positioned in a circle or rectangle region.

6. The acoustic signal transmitting apparatus of claim 1, further comprising a signal amplifier configured to amplify the acoustic signal provided from the pre-processor such that the acoustic signal drives the plurality of acoustic devices.

7. The acoustic signal transmitting apparatus of claim 1, further comprising a contact sensor configured to sense whether the plurality of acoustic devices have contacted the human body.

8. An acoustic signal transmitting apparatus comprising:
a pre-processor configured to perform processing for compensating for transfer distortion of an acoustic signal and to control beamforming of the acoustic signal; and
a plurality of acoustic devices configured to transfer the acoustic signal whose transfer distortion has been compensated for to a human body which the plurality of acoustic devices have contacted, through beamforming.

9. The acoustic signal transmitting apparatus of claim 8, wherein the pre-processor performs processing for compensating for at least one of frequency distortion of the acoustic devices and transfer frequency distortion of the human body.

10. The acoustic signal transmitting apparatus of claim 8, wherein the pre-processor controls beamforming by controlling the phase of an acoustic signal that is transferred through the plurality of acoustic devices.

11. An acoustic signal transmitting method in which an acoustic signal transmitting apparatus transmits an acoustic signal using a human body, comprising:
performing pre-processing for compensating for transfer distortion of an acoustic signal;
controlling beamforming of the acoustic signal whose transfer distortion has been compensated for; and
transferring the acoustic signal to the human body through the beamforming

12. The acoustic signal transmitting method of claim 11, further comprising, after performing the pre-processing for compensating for the transfer distortion of the acoustic signal, amplifying the acoustic signal subjected to the pre-processing.

13. The acoustic signal transmitting method of claim 11, wherein the performing of the pre-processing for compensating for the transfer distortion of the acoustic signal comprises performing processing for compensating for at least one of frequency distortion of an acoustic device which is used to transfer the acoustic signal, and transfer frequency distortion of the human body

14. The acoustic signal transmitting method of claim 11, wherein the controlling of the beamforming of the acoustic signal whose transfer distortion has been compensated for comprises controlling the phase of the acoustic signal whose transfer distortion has been compensated for.
